(19) United States
(12) Patent Application Publication
(10) Pub. No.: US 2005/0240692 A1
(43) Pub. Date: Oct. 27, 2005

(54) USB laser pen drive

(76) Inventor: I-Ying Li, Changhua Hsien (TW)

Correspondence Address: SUPREME PATENT SERVICES, POST OFFICE BOX 2339, SARATOGA, CA, 95070, US

(21) Appl. No.: 10/833,446

(22) Filed: Apr. 27, 2004

(51) Int. Cl. G06F 13/12

(52) U.S. Cl. 710/62

(57) ABSTRACT

A USB laser pen drive is provided. The USB laser pen drive comprises a housing case with a laser diode, a flash memory and a USB drive circuit. The flash memory and the USB drive circuit are both housed inside the housing case. The housing case further comprises a laser light switch, a plurality of buttons to provide operation interface to the user. The USB drive circuit further comprises a USB controller, a direct memory access, a flash memory interface, a human interface device (HID) interface, and a micro controller for controlling the operation of the USB laser pen drive.

### FIELD OF THE INVENTION

The present invention generally relates to a Universal Serial Bus (USB) device, and more specifically to a USB laser pen drive providing the functions of memory storage, a laser pen and a mouse.

### BACKGROUND OF THE INVENTION

The USB flash memory, such as USB Flash Disk, USB Pen Drive, is gaining a towering popularity because of its compact size and convenience. As the device itself is small in size and prone to misplacement, the USB flash memory device is usually integrated with other small personal accessories, such as necklaces, pens, and wristwatches. However, this kind of integration usually appears forced because the functions of the two parts do not seem naturally compatible. On many occasions of presentation, the presenter usually uses a USB flash memory to store the presentation data and a laser pen to indicate during the presentation, while operating a mouse to change present data. As the conventional laser pen uses battery to operate, it requires regular replacement of batteries. The neglect of replacing dead batteries may deem the laser pen useless on the most pressing presentation occasion. As the laser pen is often used at presentation using computer devices, it seems natural to integrate the USB flash memory for data storage with the functions of a laser pen and a mouse to create a USB laser pen drive.

### SUMMARY OF THE INVENTION

The present invention has been made to overcome the aforementioned drawback of laser pen. As the USB allows a device to have several interfaces, the present invention of a USB laser pen drive uses a mass storage interface and an HID (Human Interface Device) interface. As shown in FIG. 1, USB laser pen drive 100 of the present invention includes a housing case 200, a laser diode (LD) 101, a USB drive circuit 300, and a flash memory 102. Both USB drive circuit 300 and flash memory 102 are housed inside housing case 200.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a USB laser pen drive of the present invention;

FIG. 2a shows an external front view of a USB laser pen drive of the present invention;

FIG. 2b shows an external top view of a USB laser pen drive of the present invention; and

FIG. 3 shows a block diagram of an embodiment of the USB drive circuit of the USB laser pen drive of the present invention.

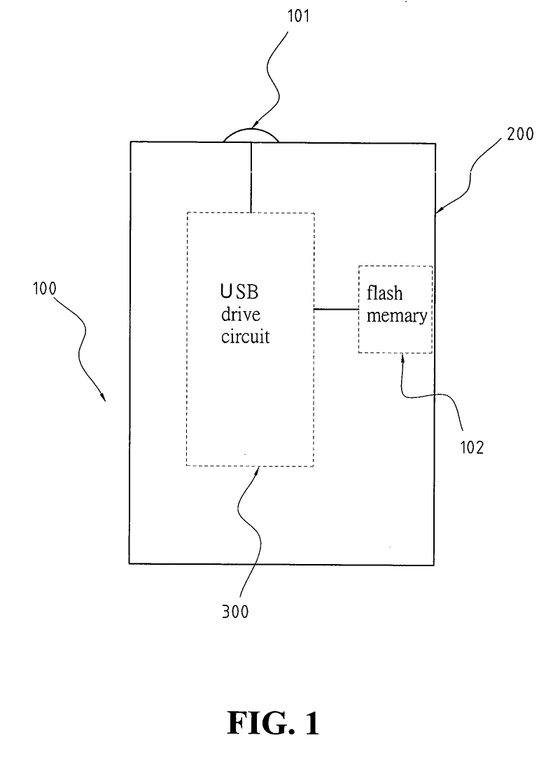

### DETAILED DESCRIPTION OF THE PREFERRED EMBODIMENTS

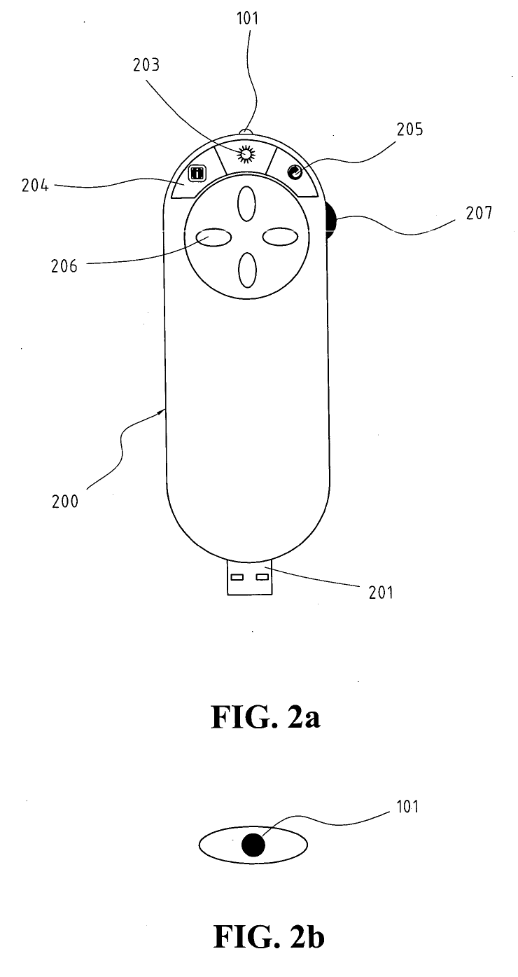

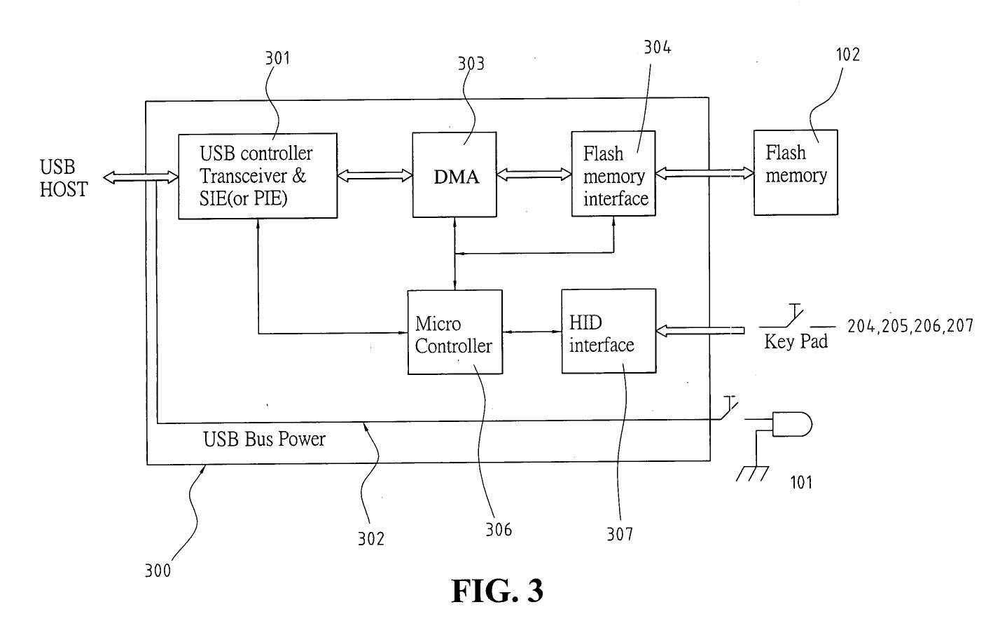

The USB laser pen drive of the present invention is a USB device including a USB drive circuit housed in an external case. FIGS. 2a and 2b show the front view and the top view of external housing case 200 of a USB laser pen drive 100 of the present invention, respectively The block diagram of an embodiment of USB drive circuit 300 is shown in FIG. 3.

Refer to FIG. 2a. The external appearance of USB laser pen drive includes a USB connector 201, a laser light switch 203, a left button 204, a right button 205, an arrow key pad 206, and a wheel 207. USB connector 201 is for connecting to the USB receptacle of the host computer. Laser light switch 203 is for controlling the ON/OFF of laser diode 101. Buttons 204, 205, 206 and wheel 207 can all be used as a pointing device of the host computer. Left button 204 and right button 205 can be used as the left and right buttons of a mouse connecting to the host computer. Arrow keypad 206 can be used as cursor moving or the arrow keys on the keyboard of the host computer. FIG. 2b shows a schematic top view of USB laser pen drive 100, in which LD 101 is exposed.

FIG. 3 shows a block diagram of an embodiment of a USB drive circuit 300 of the invention. USB drive circuit 300 includes a USB controller 301, a USB bus power line 302, a direct memory access (DMA) 303, a flash memory interface 304, a micro controller 306, and a human interface device (HID) interface 307. USB controller 301, used for connecting to the USB host, such as computer, further includes a transceiver and serial interface engine (SIE) or parallel interface engine (PIE), and is responsible for the receiving and transmission of the USB specification version 1.1 or 2.0 protocol. USB controller 301 is coupled with DMA 303 and micro controller 306. USB bus power line 302 draws power from USB host and provides operation power to both USB drive circuit 300 and LD 101. DMA 303 is coupled with USB controller 301 and flash memory interface 304 and receives control signal from micro controller 306. Flash memory interface 304 is connected to DMA 303 and a flash memory 102 for receiving and transmission of control signal timing. Flash memory 102 can be any type of flash memory. HID interface 307 is used to detect the operations of keypad or sensor 204, 205, 206, or 207. Micro controller 306 controls the operation of the entire drive circuit.

When the USB laser pen drive is plugged into the USB host, the USB host will get the device descriptor from the USB laser pen drive. The device descriptor reports the presence of two interfaces. One is a mass storage interface and the other is an HID interface. The mass storage interface uses two endpoints, i.e., bulk-in and bulk-out, while the HID interface uses one endpoint, i.e., interrupt (INT). When the USB host reads data from the mass storage interface, USB controller 301 receives the read command from the USB host and notifies micro controller 306, which then issues a read control signal to flash memory interface 304 to retrieve the requested data page from flash memory 102 for the USB host. When the USB host writes data to the mass storage interface, USB controller 301 receives the write command and the written data from the USB host and notifies micro controller 306, which then issues a write control signal to flash memory interface 304 to write the data to the requested page in flash memory 102.

The USB host also polls HID interface 307 status via the INT endpoint at an specific interval, as specified in the device descriptor. As HID interface 307 is connected to buttons 204, 205, 206 and wheel 207 (see FIG. 2a), any press on those buttons will be detected and the operation will be executed.

When the user intends to use the laser light, the user can use laser light switch 203 to switch on and off LD 101. When laser light switch 203 is switched to the ON position, LD 101 can draw power from the USB host via USB bus power line 302. Instead of using battery, LD 101 of the present invention can also draw power through a regulator from other power sources in an alternative embodiment.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A USB laser pen drive, comprising:
a housing case;
a laser diode engaged to said housing case with tip of said laser diode exposed;
a flash memory housed in said housing case for memory storage; and
a USB drive circuit housed in said housing case, coupled with said laser diode and said flash memory.

2. The USB laser pen drive as claimed in claim 1, wherein said housing case further comprises:
a USB connector for connecting a USB host;
a laser light switch for controlling the ON/OFF of said laser diode;
a plurality of buttons; and
a wheel.

3. The USB laser pen drive as claimed in claim 2, wherein said plurality of buttons further comprises a left button, a right button and an arrow key pad.

4. The USB laser pen drive as claimed in claim 1, wherein said USB drive circuit further comprises:
a USB controller;
a direct memory access (DMA) for coupling said USB controller;
a flash memory interface for coupling with said DMA and said flash memory;
a human interface device (HID) interface for coupling said buttons, said key pad and said wheel;
a USB bus power line for drawing power from said USB host; and
a micro controller for controlling the operation of said USB laser pen drive.

5. The USB laser pen drive as claimed in claim 4, wherein said USB controller further comprises a USB transceiver and a serial interface engine (SIE) for receiving and transmitting USB protocols.

6. The USB laser pen drive as claimed in claim 4, wherein said USB controller further comprises a USB transceiver and a parallel interface engine (PIE) for receiving and transmitting USB protocols.

7. The USB laser pen drive as claimed in claim 4, wherein said laser diode draws power from said USB bus power line.

8. The USB laser pen drive as claimed in claim 4, wherein said laser diode draws power from a power regulator or controller.
